(19) United States
(12) Patent Application Publication
(10) Pub. No.: US 2024/0296994 A1
(43) Pub. Date: Sep. 5, 2024

(54) METHOD FOR MANUFACTURING AN ELEMENT HAVING MAGNETIC POLES

(71) Applicants: RENAULT S.A.S, Boulogne Billancourt (FR); WHYLOT, Cambes (FR)

(72) Inventors: Jere KOLEHMAINEN, Guyancourt Cedex (FR); Thierry LAURENT, Guyancourt Cedex (FR); Florian LOUBEAU, Guyancourt Cedex (FR)

(21) Appl. No.: 18/574,694

(22) PCT Filed: Jun. 24, 2022
(86) PCT No.: PCT/EP2022/067419

§ 371 Date: Dec. 27, 2023

(30) Foreign Application Priority Data
Jun. 28, 2021 (FR) 2106912

(51) Int. Cl. H01F 41/02; H02K 15/03

(52) U.S. Cl. CPC H01F 41/0286; H02K 15/03

(57) ABSTRACT

A method for manufacturing an element having magnetic poles, includes:—supplying a magnetization block including a first main face and a second main face between them delimiting a magnetization-block thickness;—machining, over just part of the thickness of the magnetization block, a first set of initial slots, starting from the first main face, so that the magnetization block remains in one piece;—pouring a first connecting material into the initial slots;—machining a set of complementary slots, forming continuations of the initial slots of the first set over the entire thickness of the magnetization block, so as to form a plurality of individual magnets separate from one another, the individual magnets being held together by the first connecting material.

### CROSS-REFERENCE TO RELATED APPLICATIONS

This application is the US national stage of PCT/EP2022/067419, filed Jun. 24, 2022 and designating the United States, which claims the priority of FR 2106912, filed Jun. 28, 2021. The entire contents of each foregoing application are incorporated herein by reference.

### TECHNICAL FIELD OF THE INVENTION

The present invention generally relates to the field of electric machines.

More particularly, it relates to a method for manufacturing an element having magnetic poles.

The invention finds a particularly advantageous application in the production of electric motors for electric or hybrid motor vehicles (car, truck, bus, etc.). It also applies more generally to other motor-driven devices, such as lifts, cranes, etc.

### PRIOR ART

In general, an axial-flux electric machine comprises at least one stator and one rotor and an air gap separating these two types of elements in which the magnetic flux circulates. The rotor carries a series of large permanent magnets, whereas a series of coils are carried by the stator. When the coils are supplied with an electric current, the rotor, which is secured to the output shaft of the motor, is subjected to a torque resulting from the magnetic field (the created magnetic flux being an axial flux).

To reduce energy losses by eddy currents in the rotor, and thus increase the performances of the electric machine, the large permanent magnets may be replaced by “elements having magnetic poles” each including a plurality of unit magnets with reduced sizes. Indeed, a large permanent magnet is subject to greater eddy current losses than its equivalent made into small unit magnets.

The unit magnets are tightly arranged to maximise the volume of magnetic material compared to the volume of the corresponding element having magnetic poles and thus improve the performances of the electric machine.

For example, a structure comprising small-size unit magnets is known from the document FR3064422. These unit magnets have the advantage of being able to form a tight network while having a strong magnetic field. In this document, the unit magnets are held relative to each other, for example by means of a holding mesh (typically honeycomb-like shaped when the unit magnets are hexagonal), and then coated with a resin to form the element having magnetic poles.

Nonetheless, filling the volume of the element having magnetic poles with as many unit magnets as possible while limiting the manufacturing costs proves to be complex. Indeed, each unit magnet should be handled individually. In addition, the elements having magnetic poles generally have two edges with rectilinear but non-parallel shapes. Arranging unit magnets with identical shapes then necessarily generates empty spaces, filled with the resin, which reduces the magnetic efficiency of the element having magnetic poles and therefore of the rotor.

### DISCLOSURE OF THE INVENTION

In order to overcome the aforementioned drawbacks of the prior art, a method is provided according to the invention for manufacturing an element having magnetic poles for a rotor for an electric machine, said element having magnetic poles comprising a plurality of unit magnets, said method comprising the steps of:
providing a magnetisation block comprising a first main face and a second main face opposite to the first main face, the first main face and the second main face delimiting a thickness of the magnetisation block therebetween;
machining, over only part of the thickness of the magnetisation block, a first set of initial slots starting from the first main face, such that the magnetisation block remains integral;
pouring a first connecting material into the initial slots;
machining a set of complementary slots forming extensions of the initial slots of the first set across the entire thickness of the magnetisation block, so as to form the plurality of unit magnets separated from each other, the unit magnets being held secured together by the first connecting material.

Thus, thanks to the invention, the unit magnets are secured together throughout the process of manufacturing the element having magnetic poles. Hence, it is not necessary to handle them individually to arrange them according to the shape of the element having magnetic poles.

In turn, the first connecting material makes the intermediate structure (before making the complementary slots) resistant. This allows handling it, for example in a machining line, while reducing the risks of breakage. With two distinct steps of pouring a connecting material, the likelihood of a poor penetration of the connecting material at a given location is also reduced. Hence, the strength of the element having magnetic poles is increased.

In addition, the unit magnets are cut so as to best fill the volume of the element having magnetic poles. Indeed, the manufacturing method allows producing unit magnets with different shapes so as to fill the volume of the element having magnetic poles (which is then equal to the volume of the magnetisation block minus the volume of the slots) with as many unit magnets as possible and therefore with as much magnetic material as possible.

Finally, the invention allows reducing the expensive magnetic material waste since the smallest amount of material is removed off the magnetisation block, namely only a volume corresponding to the slots.

Other advantageous and non-limiting features of the manufacturing method according to the invention, considered individually or according to any technically-feasible combination, are as follows:
said method comprises, before pouring the first connecting material, a step of machining, over only part of the thickness of the magnetisation block, a second set of initial slots starting from the second main face, and wherein the set of complementary slots also forms extensions of the initial slots of the second set;
the initial slots of the first set extend according to substantially parallel first directions and wherein the initial slots of the second set extend according to substantially parallel second directions, the first directions preferably being substantially orthogonal to the second directions;
the first set comprises initial slots extending according to one direction and initial slots extending according to another direction;
the first set of initial slots comprises a subset of initial slots located opposite the initial slots of the second set;
the magnetisation block has lateral faces, each lateral face being orthogonal to one amongst two lateral directions orthogonal to each other, and wherein the initial slots extend in directions substantially parallel to either one of the two lateral directions;
the complementary slots have a width larger than that of the initial slots;
the complementary slots are offset, across the thickness of the magnetisation block, with respect to the initial slots;
said method comprises a step of pouring a second connecting material between the unit magnets, which is preferably carried out after a step of placing the element having magnetic poles in a compartment provided for in the rotor, the second connecting material being also poured around the element having magnetic poles to fasten it in the compartment;
the first connecting material and/or the second connecting material is made of a material including a magnet powder mixed in a matrix.

Of course, the different features, variants and embodiments of the invention may be associated together according to various combinations provided that they are not incompatible with or exclusive of each other.

### BRIEF DESCRIPTION OF THE DRAWINGS

The following description made with reference to the appended drawings, given as non-limiting examples, should clearly define the invention and how it could be carried out.

In the appended drawings:

FIG. 1 is a block diagram of a sequence of steps enabling the manufacture of an element having magnetic poles according to the invention;

FIG. 2 is a schematic perspective view of a magnetisation block illustrating a second step of a first embodiment of the method of FIG. 1;

FIG. 3 is a schematic perspective view of the magnetisation block of

FIG. 2 illustrating a third step of the first embodiment of the method;

FIG. 4 is a schematic perspective view of the magnetisation block of FIG. 2 illustrating a fourth step of the first embodiment of the method;

FIG. 5 is a schematic perspective view of the magnetisation block of FIG. 2 illustrating a fifth step of the first embodiment of the method;

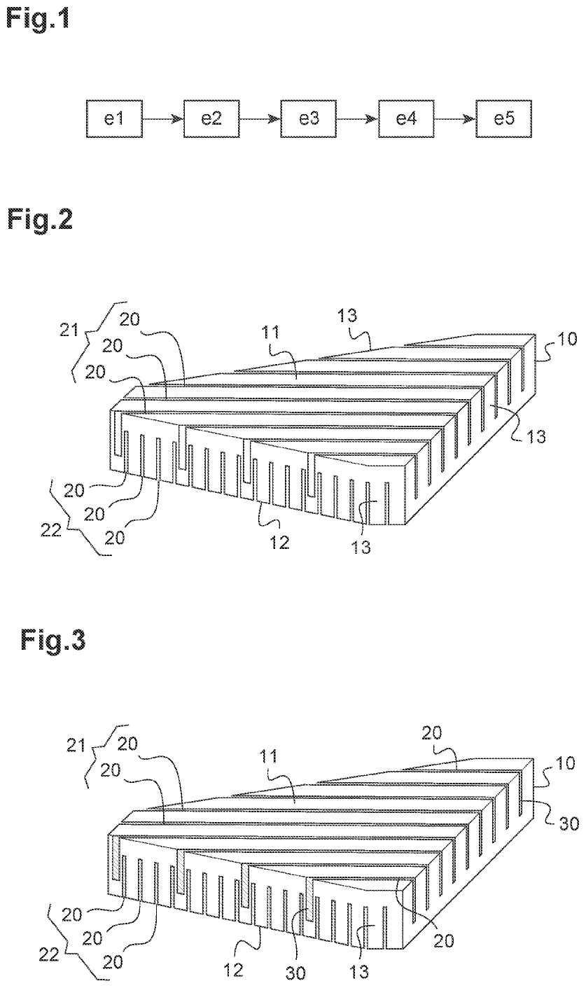

FIG. 6 is a schematic perspective view of a magnetisation block illustrating a second embodiment of the method of FIG. 1;

FIG. 7 is a schematic perspective view of a magnetisation block illustrating a third embodiment of the method of FIG. 1;

FIG. 8 is a schematic perspective top view of a magnetisation block illustrating a fourth embodiment of the method of FIG. 1;

FIG. 9 is a schematic perspective bottom view of the magnetisation block of FIG. 8;

FIG. 10 is a schematic perspective view of a magnetisation block illustrating the positioning of slots;

FIG. 11 is a schematic perspective view of the magnetisation block of FIG. 4 located in a compartment provided for in a rotor.

### DETAILED DESCRIPTION

In FIG. 5, an element having magnetic poles 1 is shown. The element having magnetic poles 1 is designed so as to be installed within a rotor (not shown) for an electric machine, herein an axial-flux electric machine, in this case a motor allowing propelling an electric vehicle.

Such an electric machine includes at least one rotor 100, only one portion of which is shown in FIG. 11, and at least one stator (not shown). In an axial-flux electric machine, the stators feature flattened ring shape and are equipped, on their faces located on the side of the rotor 100, with teeth around which windings of electrically-conductive wires are wound. When these windings are supplied with electric current, they allow generating a magnetic field. The magnetic field is axial for an axial-flux electric machine.

In turn, the rotor 100 comprises an annular shaped body 110 which accommodates a plurality of elements having magnetic poles 1. The magnetic field generated by the windings is then designed so as to act on the elements having magnetic poles 1 so as to make the rotor 100 rotate. The body 110 has a disc-like general shape, meaning that it is substantially circumscribed by an axisymmetric cylinder. The body 110 delimits a plurality of hollow compartments 120 (only one of which is shown in FIG. 11), each compartment 120 including an element having magnetic poles 1. The compartments 120 are evenly distributed around the axis of rotation A1 of the rotor 100.

As shown in FIGS. 4 and 5, each element having magnetic poles 1 comprises a plurality of unit magnets 2. These unit magnets 2 have a much smaller size than that of the element having magnetic poles 1 (at least ten times smaller). Here, for example, the element having magnetic poles 1 comprises about one hundred unit magnets 2. The unit magnets 2 herein have a generally parallelepiped shape.

The unit magnets 2 are separated from each other within the element having magnetic poles 1. Here, this means that each unit magnet 2 is physically disjoined from the other unit magnets 2 meaning that it is not in direct contact with these. This separation of the unit magnets allows limiting eddy current losses within the element having magnetic poles 1 when the electric machine is in operation. In the extreme case, by separated from each other, it should be understood that the unit magnets could be in contact with each other by contact lines, typically by their edges. The eddy current losses are then slightly higher yet still much lower than those of a large permanent magnet.

The unit magnets 2 may be of any type. These may consist of sintered neodymium magnets, commonly known as NdFeB magnets. These magnets are made of an alloy of neodymium, iron and boron. Alternatively, it may consist of a ferrite magnet, for example SmCo magnets (made of Samarium-Cobalt) or AlNiCo magnets (primarily composed of aluminium, nickel and cobalt).

As shown in FIG. 5, the unit magnets 2 are held securely together by a first connecting material 30 and by a second connecting material 50 possibly different from the connecting material 30. These connecting materials 30, 50 may consist of thermosetting polymers, such as epoxies, silicones, in all applicable forms, for example in the form of a glue, a resin, a single-component or two-component cast, or thermoplastic polymers such as Nylon or PPS (Polyphenylene Sulphide). The connecting materials 30, 50 may be applied by any method known to a person skilled in the art. Besides conferring mechanical reinforcement on the element having magnetic poles 1, these connecting materials 30, 50 allow electrically isolating the unit magnets from each other (while securing them together) and thus reducing eddy current losses.

The method for manufacturing the element having magnetic poles 1 (which method is more particularly the object of the present invention) is now described illustrated in FIG. 1 and which comprises the four main steps hereinafter.

A first step e1 comprises providing a magnetisation block 10. As illustrated for example in FIG. 2, the magnetisation block 10 has an upper face 11, herein called the upper face 11, and a lower face 12, herein called the lower face 11, which is opposite to the upper face 11. The upper face 11 and the lower face define a thickness of the magnetisation block 10 therebetween. The magnetisation block 10 is made of a magnetic material. The magnetic material is the same as that described before for the unit magnets 2 since these are directly and entirely derived from the magnetisation block 10.

The shape of the magnetisation block 10 corresponds, in negative, to that of the compartment 120 of the body 110 of the rotor 100 in which the element having magnetic poles is intended to be accommodated. Nevertheless, the dimensions of the magnetisation block 10 are slightly smaller than those of the compartment 120 in order to be able to place it there. As shown in FIG. 10, each of the upper face 11 and the lower face 12 has a generally trapezoidal shape similar to that of the compartment 120. In turn, the thickness of the magnetisation block 10 is substantially equal to the thickness of the body of the rotor 100 (its dimension according to its axis of rotation A1).

The magnetisation block 10 obtained during this first step e1 is solid, meaning that it has no slots.

As shown for example in FIG. 2, both the upper face 11 and the lower face 12 of the magnetisation block 10 are parallel to each other. The thickness of the magnetisation block 10 then corresponds to the distance between the upper face 11 and the lower face 12 and is therefore constant. The thickness herein corresponds to the dimension of the magnetisation block 10 extending according to the axis of rotation A1 of the rotor 100.

Besides the upper face 11 and the lower face 12, the magnetisation block 10 has lateral faces 13 connecting the upper face 11 to the lower face 12. Here, these lateral faces 13 are orthogonal to the upper face 11 and to the lower face 12. Once the element having magnetic poles has been manufactured and installed in the compartment 120, the lateral faces 13 extend opposite the body 110 of the rotor 100. More specifically, the lateral faces 13 then extend opposite an inner surface 113 delimiting the compartment 120.

A second step e2 comprises machining an upper set 21, herein called the upper set 21, of initial slots 20 starting from the upper face 11, over only part of the thickness of the magnetisation block 10. Here, this means that the depth of the initial slots 20, i.e. their dimension according to a direction substantially orthogonal to the upper face 11, is, at least locally, strictly smaller than the thickness of the magnetisation block 10. By “starting from”, it should be understood that the initial slots 20 of the upper set 21 open onto the upper face 11.

Machining of the initial slots 20 is carried out such that the magnetisation block 10 remains in one-piece. In other words, none of the initial slots 20 separates the magnetisation block 10 into two distinct portions. After this machining step e2, the volume forming the magnetisation block 10 is therefore continuous. As an example, FIG. 2 shows a magnetisation block 10 after machining of the initial slots 20. By machining, it should be herein understood any method allowing removing material off the magnetisation block 10, in particular sawing, milling, drilling, turning, etc.

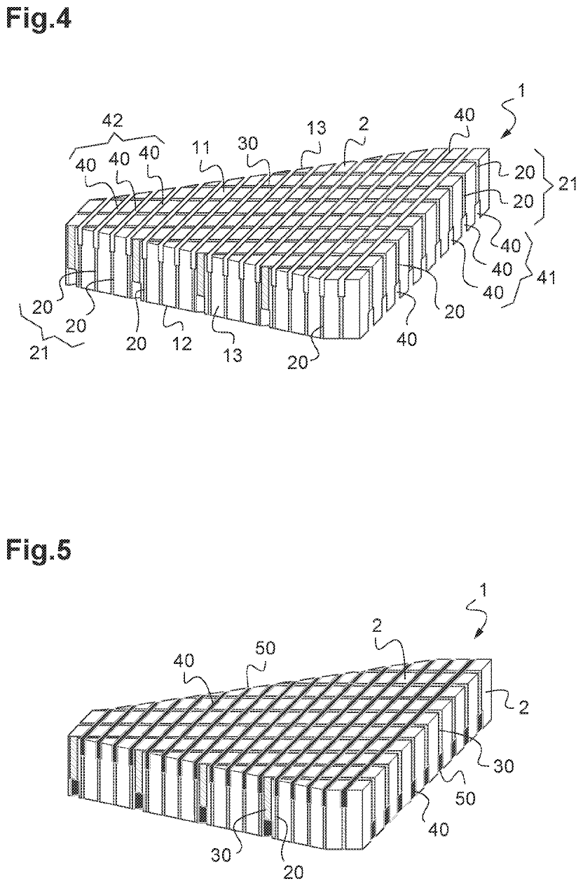

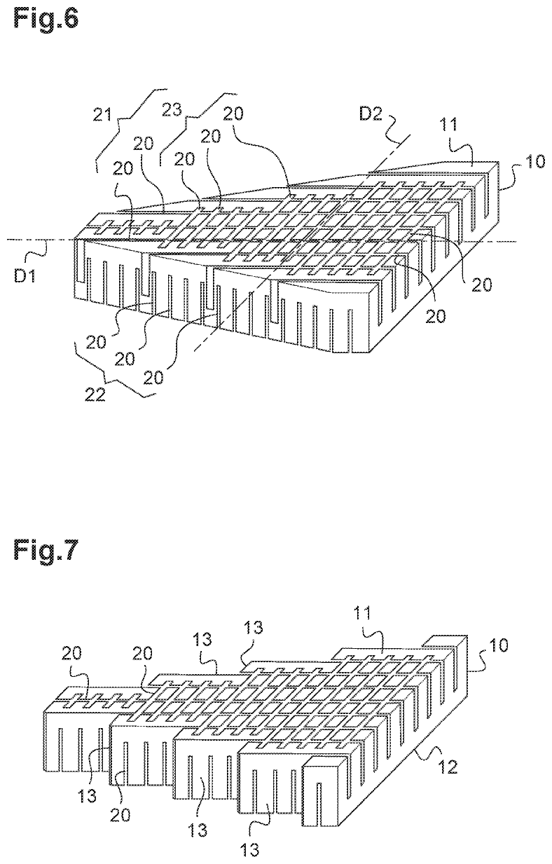

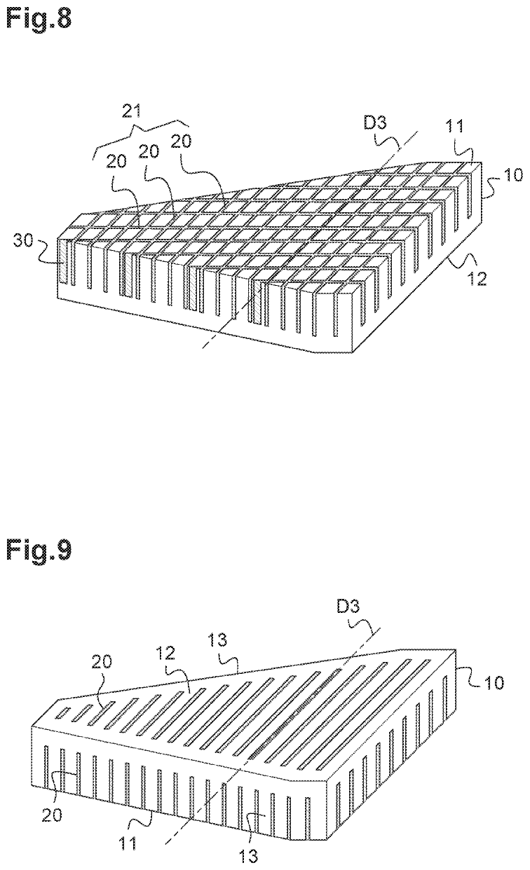

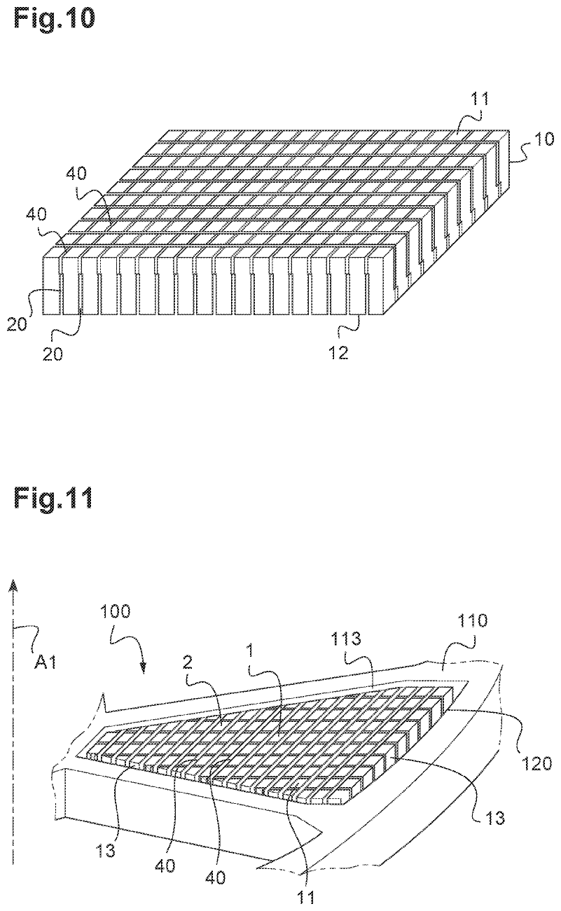

A third step e3, illustrated in FIG. 3, comprises pouring the first connecting material 30 into the initial slots 20. When it is poured, the first connecting material 30 is in a liquid or at least viscous state to fill all of the machined slots. The third step e3 herein comprises a sub-step of hardening the first connecting material 30.

A fourth step e4 comprises machining a set of complementary slots 40 forming extensions of the initial slots 20, in particular those of the upper set 21, across the entire thickness of the magnetisation block 10, so as to form the plurality of unit magnets 2. Thus, as shown in FIG. 4, the fourth step e4 aims to extend, through the complementary slots 40, the initial slots 20 across the entire thickness of the magnetisation block 10. Preferably, this fourth step e4 is carried out after hardening of the first connecting material 30.

In practice, machining the complementary slots 40 is done on the main face which is opposite to that starting from which the initial slots 20 are made. For example, the upper set 21 of initial slots 20 being machined starting from the upper face 11, the complementary slots 40 extending the upper set 21 are made starting from the lower face 12.

Hence, after machining the complementary slots 40, the unit magnets 2 are separated from each other. This means that the unit magnets 2 are no longer connected to each other by magnetic material. However, they are held secured together by the first connecting material 30.

Preferably, between the second step and the third step, the method comprises a complementary step of cleaning the slots which allows removing off the initial slots residues of magnetic material resulting from the machining of the initial slots.

For example, this cleaning is carried out by injecting a pressurised jet of air or of a cleaning solution, preferably non-corrosive (without or, preferably, with a surfactant) into the initial slots 20.

A second cleaning step is here provided for after machining of the complementary slots 40. Remarkably, machining of the complementary slots 40 forms a plurality of recesses crossing the magnetisation block 10, which facilitates cleaning thereof.

Referring to FIGS. 2 to 5, a first embodiment of the method for manufacturing the element having magnetic poles 1 is now described in detail.

In this first embodiment, the second step e2 comprises, besides machining the upper set 21 of initial slots 20 starting from the upper face 11, machining a second set 22, herein called lower set 22, of initial slots 20 starting from the lower face 12. In other words, at this step, slots are machined starting from the upper face 11 and the lower face 12. As shown in FIG. 2, the initial slots 20 are herein rectilinear, which facilitates machining and cleaning thereof. More particularly, the initial slots 20 of the upper set 21 extend according to first substantially parallel directions. Similarly, the initial slots 20 of the lower set 22 extend according to second, substantially parallel directions.

The initial slots 20 are evenly distributed over the upper face 11 and the lower face 12. On each of these faces 11, 12, all of the initial slots 20 are located at the same distance from its adjacent initial slot(s) 20. Here, the distance between two adjacent initial slots 20 is the same for those of the upper set 21 as for those of the lower set 22. Thus, the upper set 21 forms a network of initial slots 20 which are rectilinear, parallel and evenly spaced apart over the upper face 11. The same applies for the lower set 22 on the lower face 12.

Alternatively, the initial slots are not evenly distributed over the upper face. For example, the initial slots could be spaced further apart at the centre of the magnetisation block than at the periphery. Thus, the unit magnets located at the periphery of the element having magnetic poles would be smaller.

The first directions, according to which the initial slots of the first group are machined, are herein preferably substantially orthogonal to the second directions. Thus, the formed unit magnets 2 are rectangular parallelepipeds. This orthogonal configuration facilitates machining of the slots, in particular because it reduces stresses on the machining tool during machining of the complementary slots 40 and because it reduces the risk of cracking and breakage of the unit magnets 2 during formation. Alternatively, the second and first directions may be not orthogonal. Machining in non-orthogonal directions is slightly more complex but allows reducing eddy currents.

As shown in FIGS. 2 and 3, the initial slots 20 extend in depth across about 75% of the thickness of the magnetisation block. In general, the initial slots 20 extend in depth across 60% to 90% of the thickness of the magnetisation block 10. Preferably, the initial slots 20 extend across at least 50% of the thickness of the magnetisation block 10. In length, each initial slot 20 herein extends throughout the upper face 11 or the lower face 12, i.e. from one lateral face 13 to another. This means that each initial slot 20 extends from a point on the perimeter of the upper face 11 or of the lower face 12 to another point on the perimeter of this same face 11, 12.

To obtain initial slots 20 having a reduced width (dimension according to a direction orthogonal to the rectilinear extension and to the depth), i.e. fine initial slots 20, the initial slots 20 are herein made by means of a wire saw. Thus, the width of the initial slots 20 is smaller than 0.3 mm and preferably smaller than 0.2 mm. This allows maximising the volume of magnetic material in the element having magnetic poles. Here, all of the initial slots 30 have the same width. Alternatively, the initial slots may have different widths.

FIG. 3 illustrates pouring of the first connecting material 30 in the initial slots 20, i.e. herein both in those of the upper set 21 and in those of the lower set 22. The viscosity of the first connecting material 30 is herein low to be able to penetrate effectively into the initial slots 20. As shown in FIG. 3, the first connecting material 30 herein completely fills the initial slots 20.

Once the first connecting material 30 has hardened, the complementary slots 40 are machined. The result of this fourth step e4 is shown in FIG. 4.

As shown in FIG. 4, the complementary slots 40 are located opposite the initial slots 20, i.e. in the extension of these. Thus, the complementary slots 40 form a network of rectilinear, parallel and evenly spaced slots both over the upper face 11 and over the lower face 12.

The complementary slots 40 herein correspond to an extension of the initial slots 20 across the entire thickness of the magnetisation block 10. Thus, each pair formed of an initial slot 20 and a complementary slot 40 located opposite the latter forms a recess crossing the magnetisation block 10 across the entire thickness and from one lateral face 13 to another. Hence, machining of the complementary slots 40 results in the formation of the plurality of unit magnets 2 separated from each other. The element having magnetic poles 1 is then formed. It comprises the plurality of unit magnets 2 and the first connecting material 30 securing the unit magnets 2 together.

In this embodiment, each complementary slot 40 is centred with respect to the initial slot 20 it faces. Thus, the network of complementary slots 40 is aligned with the network of initial slots 20.

One could observe in FIG. 4 that the complementary slots 40 are distributed into a first group 41 of complementary slots 40 and a second group 42 of complementary slots 40. The complementary slots 40 of the first group 41 extend the initial slots 20 of the upper set 21. Conversely, the complementary slots 40 of the second group 42 extend the initial slots 20 of the lower set 22.

The complementary slots 40 of the first group 41 are herein machined starting from the lower face 12. Conversely, the complementary slots 40 of the second group 42 are herein machined starting from the upper face 11.

As shown in FIG. 4, volumes filled with the first connecting material 30 are machined. To limit clogging of the machining tool by the first connecting material 30, machining of the complementary slots 40 is herein carried out by a blade saw.

The complementary slots 40 may also be machined by laser cutting. Laser cutting is particularly interesting when the remaining thickness to be cut is small (i.e. when the initial slots 20 extend over a substantial part of the thickness of the magnetisation block 10), for example when the complementary slots 40 extending over a thickness smaller than 0.5 mm. Laser cutting may also be used for the initial slots 20.

Preferably, the complementary slots 40 have a width larger than that of the initial slots 20. Here, all complementary slots 40 have the same width which is for example smaller than 0.8 mm and preferably smaller than 0.5 mm. Alternatively, the complementary slots could have a width smaller than that of the initial slots, in particular in the case where the complementary slots are made by laser cutting. In general, it is actually simpler to make fine complementary slots than fine initial slots. In all embodiments (but illustrated only in this first embodiment), the method also comprises a step e5 of pouring the second connecting material 50. As illustrated in FIG. 5, the second connecting material 50 is poured into the complementary slots 40. The second connecting material 50 allows solidifying the element having magnetic poles 1.

In practice, pouring of the second connecting material 50 is preferably carried out when the element having magnetic poles 1 is positioned in the compartment 120 of the body 110 of the rotor 100 provided to this end (as is the case in FIG. 11). Thus, the second connecting material 50 may be poured both in the complementary slots 40 and around the element having magnetic poles 1 to fix the latter with respect to the body. The second connecting material 50 is then more specifically poured at the periphery of the lateral faces 13, between these and the inner surface 113 of the compartment 120. Alternatively, the second connecting material is poured only in the complementary slots, for example by placing the element having magnetic poles in a mould.

Here, the second connecting material 50 comprises a matrix into which a magnet powder is mixed. Thus, a considerable predominant portion of the volume of the compartment 120 is filled with a material having magnetic properties (the element having magnetic poles 1 or the second connecting material 50) which allows improving the magnetic performances of the rotor. In particular, the use of a magnet powder allows creating an intermediate magnetism area between a non-magnetic area (the body) and a strongly magnetic area (the element having magnetic poles), which contributes in reducing losses. Finally, the element having magnetic poles 1 itself comprises more material with magnetic properties.

For example, the matrix is made of one of the previously-described connecting materials. To improve adhesion between the first and second connecting materials, the matrix is preferably made of the same material as the first connecting material 30.

The magnet powder is made up of crystals, for example with spherical shapes. Preferably, the volume content of magnetic powder in the polymer material is comprised between 50 and 85%. Preferably, the diameter of the grains in the magnet powder is comprised between 2 and 100 micrometres (μm). In particular, it is comprised between 80 and 100 μm in the case of injection moulding.

The magnet powder makes the second connecting material 50 more viscous (than the matrix itself) when poured. However, the fact that the complementary slots 40 are wider than the initial slots 20 facilitates the penetration of the second connecting material 50 between the complementary slots 40. Alternatively to this first embodiment, the first connecting material may also comprise a magnet powder. Still alternatively, the second connecting material may be devoid of magnet powder.

A second embodiment is illustrated in FIG. 6. More particularly, FIG. 6 illustrates the second step e2 of the method. It differs from the first embodiment in that the upper set 21 comprises, besides the initial slots 20 extending according to one direction, initial slots 20 extending according to another direction (still starting from the upper face 11).

The idea herein consists in anticipating the fourth step e4 by machining more initial slots 20 during the second step e2. In particular, this allows, during the fourth step e4, machining a more limited volume of first connecting material 30. This also allows making the element having magnetic poles more resistant once the fourth step e4 is completed since the complementary slots 40 occupy a narrower volume.

As shown in FIG. 6, the upper set 21 more specifically comprises initial slots 20 extending according to a reference direction D1 and initial slots 20 extending according to a direction perpendicular D2 to this reference direction D1. The initial slots 20 extending according to this perpendicular direction D2, consist of a subset 23 of initial slots 20 included in the upper set 21.

The initial slots 20 of the subset 23 are herein located opposite the initial slots 20 of the lower set 22. Preferably, the initial slots 20 of the subset 23 are contiguous with the initial slots 20 of the lower set 22. This means that the pair formed by an initial slot 20 of the subset 23 and an initial slot 20 of the lower set 22 forms a continuous opening across the entire thickness of the magnetisation block 10, i.e. from the upper face 11 to the lower face 12 (but without splitting the magnetisation block in two).

The initial slots 20 of the subset 23 extend in an area of the upper face 11 circumscribed within the perimeter of the upper face 11. In other words, the initial slots 20 of the subset 23 do not open onto the lateral faces 13.

In a third embodiment, illustrated in FIG. 7, the lateral faces 13 are planar and arranged orthogonally to each other along the periphery of the upper face 11 and the lower face 12.

As shown in FIG. 7 (which more particularly illustrates the second step e2 of the method), the initial slots 20 extend either parallel or orthogonal to the lateral faces 13. This means that each initial slot 20 extends parallel to some of the lateral faces 13 and orthogonal to the other lateral faces 13.

Thus, in this third embodiment, all unit magnets 2 are substantially identical and have a rectangular parallelepiped shape. This makes the element having magnetic poles 1 more solid than that of the first and second embodiment shown in FIGS. 2 to 6. Indeed, compared to these two embodiments, the element having magnetic poles 1 herein does not comprises pyramidal shaped fine unit magnets 2 at the lateral faces 13. These considered unit magnets 2 are more fragile and therefore more prone to become detached from the element having magnetic poles 1 during manufacture or transport thereof.

In a fourth embodiment, illustrated in FIGS. 8 and 9 (which show the front side and back side of the same element having magnetic poles), all of the initial slots 20 are machined starting from the upper face 11. Thus, in the second step e2, only the upper set 21 of initial slots 20 is made. In the example illustrated in FIG. 8, the upper set 21 comprises initial slots 20 extending in a reference direction and initial slots 20 extending according to a direction perpendicular to this reference direction.

The particularity of this fourth embodiment is that some of the initial slots 20 extend, over only part of their length, across the entire thickness of the magnetisation block 10. This is particularly visible in FIG. 9 which shows the magnetisation block 10 viewed from the lower face 12 (at the end of the third step e3). Here, in a central area of the magnetisation block 10, all of the initial slots 20 extending according to a lateral direction D3 extending in depth across the entire thickness of the magnetisation block 10. In a central area herein means that this extension across the entire thickness is not done from one lateral face 13 to another so as to preserve the unity of the magnetisation block 10.

In this fourth embodiment, all of the complementary slots 40 are then machined starting from the lower face 12. This embodiment simplifies the manufacturing process of the element having magnetic poles 1 since it is not necessary to flip over the magnetisation block 10, neither in the second step e2 nor in the fourth step e4.

FIG. 10 illustrates a portion of a magnetisation block 10 comprising initial slots 20 and on which the position of the complementary slots 40 that will be machined in the fourth step e4 is indicated. Here, the complementary slots 40 are offset, in the thickness of the magnetisation block 10, with respect to the initial slots 20. By “offset”, it should be understood that each complementary slot 40 is off-centre with respect to its associated initial slot 20. Thus, for example, in FIG. 10, each complementary slot 40 is in contact with the opposite initial slot 20 at a rectilinear edge.

The present invention is in no way limited to the described and illustrated embodiments, but a person skilled in the art will be able to impart thereon any variation in accordance with the invention. In particular, the invention is applicable to elements with parallelepiped magnetic poles, for example rectangular parallelepiped shaped like in FIG. 10. The invention is also applicable to radial-flux machines including a rotor with permanent magnets. In this case, the lower and upper faces are preferably curved around the axis of rotation of the rotor.

1. A method for manufacturing an element having magnetic poles for a rotor for an electric machine, said element having magnetic poles comprising a plurality of unit magnets, said method comprising the steps of:
providing a magnetisation block comprising a first main face and a second main face opposite to the first main face, the first main face and the second main face delimiting a thickness of the magnetisation block therebetween;
machining, over only part of the thickness of the magnetisation block, a first set of initial slots starting from the first main face, such that the magnetisation block remains integral;
pouring a first connecting material into the initial slots;
machining a set of complementary slots forming extensions of the initial slots of the first set across the entire thickness of the magnetisation block, so as to form the plurality of unit magnets separated from each other, the unit magnets being held secured together by the first connecting material.

2. The method according to claim 1, said method comprising, before pouring the first connecting material, a step of machining, over only part of the thickness of the magnetisation block, a second set of initial slots starting from the second main face, and wherein the set of complementary slots also forms extensions of the initial slots of the second set.

3. The method according to of claim 2, wherein the initial slots of the first set extend according to substantially parallel first directions and wherein the initial slots of the second set extend according to substantially parallel second.

4. The method according to claim 1, wherein the first set comprises initial slots extending according to one direction and initial slots extending according to another direction.

5. The method according to claim 2, wherein the first set of initial slots comprises a subset of initial slots located opposite the initial slots of the second set.

6. The method according to claim 1, wherein the magnetisation block has lateral faces, each lateral face being orthogonal to one amongst two lateral directions orthogonal to each other, and wherein the initial slots extend in directions substantially parallel to either one of the two lateral directions.

7. The method according to claim 1, wherein the complementary slots have a width larger than that of the initial slots.

8. The method according to claim 1, wherein the complementary slots are offset, across the thickness of the magnetisation block, with respect to the initial slots.

9. The method according to claim 1, said method comprising a step of pouring a second connecting material between the unit magnets, the second connecting material being also poured around the element having magnetic poles to fasten the element having magnetic poles it in the compartment.

10. The method according to claim 9, wherein the first connecting material and/or the second connecting material is made of a material including a magnet powder mixed in a matrix.

11. The method of claim 3, wherein the first directions are substantially orthogonal to the second directions.

12. The method of claim 9, wherein the step of pouring a second connecting material between the unit magnets is carried out after a step of placing the element having magnetic poles in a compartment provided for in the rotor.
